(19) United States
(12) Patent Application Publication
(10) Pub. No.: US 2017/0044060 A1
(43) Pub. Date: Feb. 16, 2017

(54) Method and device for cooling and comminuting hot cement clinker

(71) Applicant: KHD Humboldt Wedag GmbH, Koeln (DE)

(72) Inventor: Martin Bobowk, Bonn (DE)

(21) Appl. No.: 15/304,639

(22) PCT Filed: Apr. 16, 2015
(86) PCT No.: PCT/EP2015/058267

§ 371 Date: Oct. 17, 2016

(30) Foreign Application Priority Data
Apr. 17, 2014 (DE) 102014005748.8

(51) Int. Cl. C04B 7/47; F27B 7/38; F27D 15/02; C04B 7/52

(52) U.S. Cl. CPC C04B 7/475; C04B 7/52; F27B 7/383; F27D 15/0206

(57) ABSTRACT

A method and device for cooling and comminuting hot cement clinker in a cooler. The cooler has an inlet region for receiving the hot clinker, a recuperation region, a final cooling region having a clinker cooling device, an opening for blowing cooling air into the recuperation region, a tertiary air line for conducting away heated cooling air, an outlet region for discharging cooled clinker, and at least one conveyor to transport the clinker through the cooler. The hot clinker is tipped into the cooler through an input opening into the inlet region. The clinker is transported by the conveyor from the inlet region, through the recuperation region and the final cooling region to the outlet region, and ambient air is blown as cooling air into the recuperation region through the opening. Comminution of the clinker is provided by a device arranged in the recuperation region.

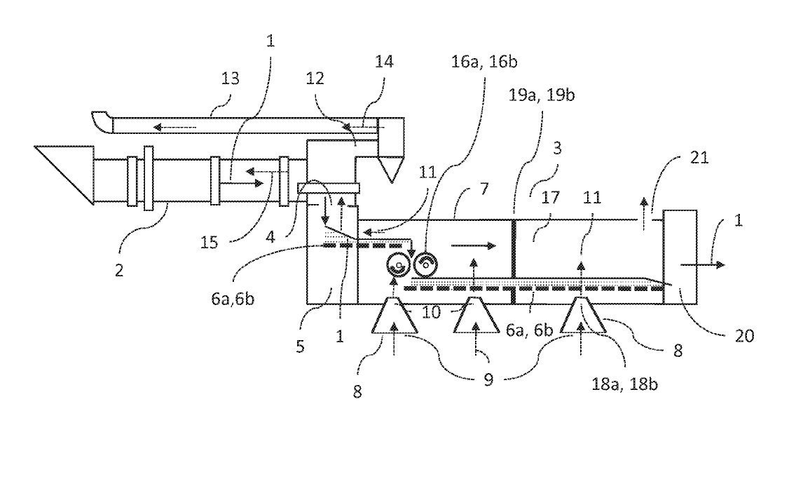

### CROSS-REFERENCES TO RELATED APPLICATIONS

This application claims the benefit of the German patent application No. 10 2014 005 748.8 filed on Apr. 17, 2014, the entire disclosures of which are incorporated herein by way of reference.

### BACKGROUND OF THE INVENTION

The invention relates to a method for cooling and comminuting hot cement clinker in a cooler, wherein the cooler has at least one inlet region for receiving the hot cement clinker, a recuperation region for the heat-recovering cooling of the hot cement clinker, a final cooling region having at least one device for further cooling the cement clinker, at least one opening for blowing cooling air into the recuperation region, a tertiary-air line for conducting away heated cooling air, an outlet region for collecting and discharging cooled cement clinker, and at least one conveying means, through which flow is able to take place, for transporting the cement clinker through the cooler, and wherein the hot cement clinker is tipped into the cooler from above through at least one input opening in the at least one inlet region, the hot cement clinker is transported by the at least one conveying means from the at least one inlet region, through the recuperation region and the final cooling region, to the outlet region, ambient air as cooling air is blown into the recuperation region through the at least one opening, and a part of the cooling air (tertiary air) heated in the recuperation region is conducted away through the tertiary-air line above the recuperation region and a further part of the cooling air (secondary air) heated in the recuperation region is conducted away out of the cooler through the input opening. The invention also relates to a device, corresponding thereto, for cooling and comminuting hot cement clinker, having a cooler with at least one input opening for receiving the hot cement clinker in at least one inlet region, at least one opening for blowing cooling air into a recuperation region adjoining the inlet region, a tertiary-air opening, arranged above the recuperation region, for conducting away a part of the heated cooling air through a tertiary-air line, and with a device for further cooling the cement clinker in a final cooling region, and at least one conveying means, through which flow is able to take place, for transporting the cement clinker from the inlet region, through the recuperation region and the final cooling region bordering the recuperation region, into an outlet region, adjoining the final cooling region, for collecting and discharging cooled cement clinker.

In the cement production method, calcined cement raw meal is burnt to form cement clinker in a rotary kiln. The hot cement clinker then drops out of the rotary kiln through an input opening into the inlet region of a clinker cooler which is used to cool the cement clinker. Most frequently, the cement clinker drops onto an inclined plane and passes from there onto a conveying means, for example onto a movable grating. The conveying means transports the cement clinker through the cooler, which extends in a longitudinal direction, until the cooled cement clinker is discharged in the outlet region of the cooler. In a first zone, immediately adjoining the inlet region, the hot cement clinker is cooled usually by way of cooling air which is blown into the cooler from below with the aid of fans. The cooling air then flows from bottom to top through intermediate spaces between the pieces of cement clinker in the material bed on the grating. In this first zone, the recuperation region, the cooling air heats up to above 1000° C. during the cooling operation since the cement clinker is burnt in the furnace at temperatures of at least 1400° C. One of the essential elements of the method is that the heat extracted from the material bed can be utilized again or recovered in that it is passed back into the process. Some of the hot air is conducted as combustion air or secondary air from the recuperation region into the rotary kiln, where the recovered heat is reused for the burning process. The rest of the heated cooling air from the recuperation region is conducted as tertiary air in particular into the calciner, in which the sintering of the raw meal in the rotary kiln is preceded by deacidification of the raw meal. One of the central requirements of the process design is to realize recovery that is as effective as possible, since the utilization of the heat energy results, in particular, in an economically favorable reduction in the fuel requirement of the clinker burning process. The recuperation region is adjoined in the longitudinal direction in the cooler by the final cooling region as a second cooling zone. Cooling can take place herein by radiation or by indirect cooling. However, an air cooling system is frequently used here, too. Because the cement clinker has already cooled considerably, the cooling air heats up in the final cooling region only to a small extent (typically to temperatures between 200° C. and 350° C.). It has been shown that rapid, effective and uniform cooling of the cement clinker is of particular importance for the quality of the cement. However, quick and uniform cooling is counteracted by the fact that the cement clinker that passes into the cooler from the rotary kiln contains some comparatively large pieces, which unfavorably deflect or block the air stream. Furthermore, depending on the size or surface area of the lumps of cement clinker, different cooling times arise.

In order to achieve cooling of the hot cement clinker that is as quick as possible, the use of devices for comminuting the cement clinker in or directly upstream of the cooler has been proposed. Frequently, a crusher is provided to improve final cooling, wherein the crusher is arranged between the recuperation region and the final cooling region, usually approximately in the middle of the cooler length, and the cooling system in the final cooling region can be different (radiation cooler, air cooler, indirect cooler etc.). The recuperation region is not precisely definable, but is the region in which air is usually obtained for recovery. Examples of such arrangements and corresponding methods are disclosed, in particular, in DE 102011055658 B3, DE 2404086 and DE 1941345. A disadvantage when the crusher is arranged between the two cooling regions or at the end of the recuperation region is that the cooling is as a result improved, i.e., accelerated and rendered more uniform, only for the final cooling region, but not for the start of the cooling process which is characterized by high temperatures. Furthermore, there is no improvement in recovery, i.e., the amount of heat energy returned to the rotary kiln is not increased.

Examples of the arrangement of crushers, in particular of roller or jaw crushers, in the inlet region between the rotary kiln and cooler region are given in particular in DE 69605209 T2, DE 9304122 U1 and DE 4124878 A1. However, it must be kept in mind that such comminuting devices which are mounted upstream of the cooler are exposed to particularly high temperatures since the hot cement clinker drops onto the crushers directly and therefore in an uncooled state after exiting the rotary kiln. This results in uneconomically high material wear to the crushers and/or in the need for continuous cooling of the crusher. Although such cooling can be carried out, it also results, in the inlet region, in a temperature drop in the secondary and tertiary air flowing through this region. Additional cooling systems for the crushers, for example liquid cooling in the interior of rollers, therefore have the consequence, as a procedural and economic disadvantage, not only of greater complexity in the installation, but also of a reduction in recovery, even though the reduction is not particularly great.

### SUMMARY OF THE INVENTION

Therefore, it is an object of the invention to propose a method for cooling and comminuting hot cement clinker with a high cooling performance, this method overcoming the disadvantages of the prior art. An object of the invention also includes proposing a device, corresponding to this method, for cooling and comminuting hot cement clinker.

In the method according to the invention, provision is made to comminute the hot cement clinker in the recuperation region. To this end, at least one device for comminuting the cement clinker should be arranged in the recuperation region of the cooler, preferably in the initial region, adjoining the inlet region, of the recuperation region. Once the hot cement clinker has passed from the rotary kiln into the inlet region and from there into the recuperation region, it is fed to the comminuting device by the conveying means, for instance a movable grating. Comminution generally comprises crushing, brought about by pressure, of the larger pieces in the material bed of the hot cement clinker. After passing through the comminuting device, the cement clinker is transported through the further recuperation region by the conveying means and then passes into the final cooling region after being cooled to several hundred degrees Celsius.

The method of arranging the device for comminuting the cement clinker in the recuperation region has the advantage, compared with arranging a crusher between the recuperation region and final cooling region, that the large lumps in the cement clinker material bed are already comminuted in the recuperation region, preferably at the start thereof. This results in a material bed in which, on account of a sufficiently large number of intermediate spaces and channels between the comminuted pieces of cement clinker, the cooling air can flow easily from bottom to top through the material bed. Heat exchange is increased by the enlarged surface area of the cement clinker material bed. Overall, it is thus already possible to achieve an increased cooling performance, i.e., more uniform and more rapid cooling in the recuperation region. This not only contributes to a high cement quality; there is also a high recovery performance, since the heat energy extracted from the heat bed can be conducted directly back to the processes of burning and calcining, with the correspondingly heated cooling air as secondary and tertiary air, without appreciable cooling. There is thus a significant advantage over arrangements in which a crusher is still connected upstream of the cooler in the inlet region and which are thus either exposed to heavy material wear to the crusher or require additional cooling which reduces the recovery performance.

The required cooling of the device for comminuting the hot cement clinker in the recuperation region of the cooler takes place by means of the cooling-air stream, which is also used for cooling the cement clinker. The cooling of the comminuting device accordingly does not counteract the recovery, but contributes to heating the cooling air in the recuperation region. If, in individual cases, cooling by the cooling-air stream is not sufficient, additional internal cooling of the crusher, for instance cooling of a roller crusher with a liquid coolant in the interior of the rollers, may be carried out. However, when heat resistant materials (steel) are used for the crusher, the intensity of this additional cooling can always be kept small enough that it does not result in significant cooling of the secondary and/or tertiary air.

One configuration of the invention provides for the hot cement clinker to be comminuted in the recuperation region in a roller crusher as the comminuting device. The known technique of comminuting crumbly material under high pressure in the gap between two counterrotating rollers can be used here to comminute large pieces in the cement clinker. Since the roller gap is charged with less material from the conveying means, most frequently from above, in the recuperation region than is the case with high-pressure rolling presses, the material bed comminution takes place as the crushing operation. The roller crusher releases comminuted cement clinker from the roller gap onto a further section of the conveying system on the other side. Roller crushers have the advantage of reliable and economical operation.

One configuration of the invention provides for the hot cement clinker to be transported in the cooler by means of at least one movable grating or by way of a conveying device, for example movable rakes. Typically, this is a conveying system made up of a first movable grating which transports the cement clinker from the inlet region to the device for comminuting the cement clinker, i.e., more or less as far as a roller crusher in the recuperation region. Once it has passed through the roller gap, the cement clinker drops onto a further movable grating on which the further transportation through the recuperation region and through the final cooling region to the outlet region takes place. It is known that the configuration of the conveying means as a system of movable gratings between the inlet region and the outlet region of the cooler affords a number of advantages. These include not only the simple, expedient and durable construction of each such grating, but also the controllability of the transportation speed and the uniform distribution with which the cement clinker is arranged as bulk material on the grating. In particular, on account of its shape, a grating is permeable to the cooling air flowing against it from below.

The cooling of the cement clinker in the final cooling region can take place using various methods, for example by radiation or indirect cooling. One configuration of the invention provides for cooling air to be used for cooling here, too. This cooling air is blown into the cooler from below by one or more fans from the cool ambient air of the cooler through in each case one cooling-air opening, and has the advantage of effective and uniform cooling of the cement clinker. Typically, it flows through the cement clinker on a grating from bottom to top. On account of the considerable cooling of the cement clinker that has already taken place, the cooling air typically heats to temperatures between 200° C. and 350° C. in the final cooling region. The heated cooling air is conducted out of the final cooling region through an extraction opening arranged above the final cooling region.

For the case of air cooling in the final cooling region, a further configuration of the invention provides for the recuperation region and the final cooling region in the cooler to be separated as extensively as possible by a suitable separating means. For example, a partition wall can be arranged between the regions, the partition wall merely having an orifice for the bulk material bed on the conveying means, for instance on a movable grating. Thus, intermixing of the cooling air flows of the two regions is largely prevented in the method. Such intermixing would reduce the effectiveness of the cooling process in the final cooling region as a result of the influx of very hot air into the latter. Conversely, the temperature of the tertiary air and secondary air in the recuperation region would drop, and this would be disadvantageous for the further use of the tertiary air in the calciner and of the secondary air in the rotary kiln.

In a manner corresponding to the method according to the invention, a device according to the invention for cooling and comminuting hot cement clinker is proposed, in which at least one device for comminuting the hot cement clinker is arranged in the recuperation region of the cooler. Typically, a crusher is arranged at the start of the recuperation region, i.e., directly downstream of the inlet region. It comminutes the large pieces in the material bed of the hot cement clinker and in this way accelerates the cooling thereof and renders it more uniform.

### BRIEF DESCRIPTION OF THE DRAWINGS

The invention is explained in more detail by way of the following FIGURE, in which:

The FIGURE shows a device according to the invention for cooling and comminuting hot cement clinker in schematic cross section, in the exemplary embodiment with a roller crusher, air cooling in the final cooling region, a partition wall and movable gratings.

### DETAILED DESCRIPTION OF THE PREFERRED EMBODIMENTS

The FIGURE schematically illustrates the path of the cement clinker 1 in a section of an installation for producing cement. From the preceding method step, hot cement clinker 1 passes from a rotary kiln 2 into the cooler 3 in that the hot cement clinker 1 is tipped downwardly into the inlet region 5 of the cooler 3 through the input opening 4. (The rotary kiln 2 is illustrated in a smaller manner in relation to the cooler 3.) The hot cement clinker 1 is transported through the cooler 3 (from left to right in the depiction) by way of a conveying means 6a, 6b, movable gratings 6b in the exemplary embodiment illustrated.

The hot cement clinker 1 passes from the inlet region 5 into the recuperation region 7 by sliding on an inclined plane (not illustrated). The exemplary embodiment shows two fans 8 for the recuperation region 7, the fans 8 drawing in cool ambient air 9 and blowing the air into the cooler 3 from below through in each case one opening 10. The cooling air 11 flows from bottom to top through intermediate spaces in the movable grating 6b and penetrates further upward through intermediate spaces in the cement clinker 1 present as bulk material. In the process, the cement clinker 1 is cooled and the cooling air 11 is correspondingly heated greatly. The heat extracted from the cement clinker bed is used for recovery in the overall process in that a part of the heated cooling air 11 is conducted into the tertiary-air line 13 through the tertiary-air opening 12. It flows back, as hot tertiary air 14, into the calciner (not indicated) which is arranged upstream of the rotary kiln 2. A further part of the heated cooling air 11 flows as secondary air 15 directly into the rotary kiln 2 through the inlet region 5.

Arranged in the recuperation region 7 is a device 16a, 16b for comminuting cement clinker 1. In the exemplary embodiment illustrated, this is a roller crusher 16b comprising two counterrotating rollers. By being transported on the movable grating 6b, the material bed comprising hot cement clinker 1 passes into the roller gap between the two rollers, wherein the roller gap is arranged with its longitudinal extent transversely to the direction of transportation and parallel to the grating 6b. As a result of the high pressure in the roller gap, the cement clinker 1 is broken into fragments of such a size that they can pass through the roller gap. They drop onto a further grating 6b downstream of the roller crusher 16b in the direction of material flow, the further grating 6b transporting them further through the recuperation region 7 of the cooler 3. The cooling air 11 likewise flows against both the comminuted material bed and against the roller crusher 16b, extracting heat therefrom and leaving the recuperation region 7 as secondary air 15 or tertiary air 14. The roller crusher 16b is expediently arranged in the front part of the recuperation region 7 with regard to the material flow (not true to scale in the depiction). In this way, effective and very uniform cooling of the hot cement clinker 1 that is present in relatively small pieces downstream of the roller crusher 16b occurs over a sufficiently long section in the recuperation region 7. Furthermore, the rollers do not as a result heat up so greatly as to be subjected to damage. The cooling air 11 is heated to a correspondingly great extent in this region.

After the cooling phase in the recuperation region 7, the cement clinker 1 is transported into the adjoining final cooling region 17 on a grating 6b. An air cooling system is likewise provided in the exemplary embodiment as the device 18a, 18b for further cooling the cement clinker 1 in the final cooling region 17. Ambient air 9 is drawn in by the fan 8, of which there is one in the exemplary embodiment, in the final cooling region 17, and is blown as cooling air 11 into the final cooling region 17 through the cooling-air opening 18b. In this way, uniform cooling of the cement clinker 1 takes place as it is being transported through the final cooling region 17.

In order to prevent intermixing of the flows of cooling air 11 from the recuperation region 7 and from the final cooling region 17 as much as possible, a partition wall 19b is arranged as separating means 19a, 19b between the recuperation region 7 and final cooling region 17 in the exemplary embodiment illustrated, said partition wall 19b reaching as far as the bulk material on the grating 6b on both sides. After the second cooling phase in the final cooling region 17, the cement clinker 1 reaches the outlet region 20, where it is discharged and is passed into the further procedure of cement production. The heated cooling air 11 from the final cooling region 17 is conducted away through an extraction opening 21 and can optionally be used for further processes on account of its heat (not depicted).

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1-10. (canceled)

11. A method for cooling and comminuting hot cement clinker in a cooler wherein the cooler has
at least one inlet region for receiving the hot cement clinker,
a recuperation region for the heat-recovering cooling of the hot cement clinker,
a final cooling region having at least one device for further cooling the cement clinker,
at least one opening for blowing cooling air into the recuperation region,
a tertiary-air line for conducting away heated cooling air,
an outlet region for collecting and discharging cooled cement clinker, and
at least one conveying means, through which flow is able to take place, for transporting the cement clinker through the cooler,
comprising the steps:
tipping the hot cement clinker into the cooler from above through at least one input opening in the at least one inlet region,
transporting the hot cement clinker by the at least one conveying means from the at least one inlet region, through the recuperation region and the final cooling region, to the outlet region,
blowing ambient air as cooling air into the recuperation region through the at least one opening, and
conducting a part of the heated cooling air, as tertiary air, in the recuperation region away through a tertiary-air line above the recuperation region and
conducting a further part of the heated cooling air, as secondary air, in the recuperation region out of the cooler through the input opening, and
comminuting the cement clinker by at least one device, arranged in the recuperation region.

12. The method as claimed in claim 11, wherein the cement clinker is comminuted in the recuperation region by at least one roller crusher.

13. The method as claimed in claim 11, wherein the cement clinker is cooled in the final cooling region by ambient air as cooling air, which is blown into the final cooling region of the cooler substantially from bottom to top through at least one cooling-air opening, wherein the heated cooling air is conducted away from the final cooling region through an extraction opening.

14. The method as claimed in claim 13, wherein intermixing of the cooling air in the recuperation region with the cooling air in the final cooling region is largely prevented by a separating means provided between the recuperation region and the final cooling region and arranged outside the cement clinker located on the at least one conveying means.

15. The method as claimed in claim 11, wherein the cement clinker in the cooler is transported from the inlet region to the outlet region by at least one movable grating as the conveying means.

16. A device for cooling and comminuting hot cement clinker, comprising:
a cooler with at least one input opening for receiving the hot cement clinker in at least one inlet region,
at least one opening for blowing cooling air into a recuperation region adjoining the inlet region,
a tertiary-air opening, arranged above the recuperation region, for conducting away a part of the heated cooling air through a tertiary-air line,
a device for further cooling the cement clinker in a final cooling region,
at least one conveyor, through which air flow is able to take place, configured to transport the cement clinker from the inlet region, through the recuperation region and the final cooling region bordering the recuperation region, into an outlet region, adjoining the final cooling region, configured to collect and discharge cooled cement clinker, and
at least comminuting device for the cement clinker arranged in the recuperation region of the cooler.

17. The device as claimed in claim 16, wherein the cement clinker comminuting device is a roller crusher.

18. The device as claimed in claim 16, wherein the device for further cooling the cement clinker in the final cooling region comprises at least one cooling-air opening for blowing ambient air as cooling air into the final cooling region, wherein an extraction opening for conducting the heated cooling air out of the final cooling region is arranged above the final cooling region.

19. The device as claimed in claim 18, wherein a separator, configured to largely preventing intermixing of the cooling air in the recuperation region with the cooling air in the final cooling region, is arranged between the recuperation region and the final cooling region outside the cement clinker located on the conveyor.

20. The device as claimed in claim 16, wherein the at least one conveyor comprises at least one movable grating.
